(19) United States
(12) Patent Application Publication
(10) Pub. No.: US 2010/0193325 A1
(43) Pub. Date: Aug. 5, 2010

(54) METHOD OF CONVEYING PREFORMS AND HIGH SPEED DEVICE FOR TIPPING PREFORMS

(75) Inventors: Alain Charpentier, Octeville Sur Mer (FR); Eric Leroux, Octeville Sur Mer (FR); Gerard Perrot, Octeville Sur Mer (FR)

Correspondence Address: SUGHRUE MION, PLLC, 2100 PENNSYLVANIA AVENUE, N.W., SUITE 800, WASHINGTON, DC, 20037, US

(73) Assignee: SIDEL PARTICIPATIONS, Octeville Sur Mer (FR)

(21) Appl. No.: 12/596,365

(22) PCT Filed: Apr. 20, 2007
(86) PCT No.: PCT/FR07/00673

§ 371 Date: Mar. 30, 2010

(51) Int. Cl. B65G 47/24

(52) U.S. Cl. 198/382

(57) ABSTRACT

Method of orienting preforms, wherein in a first step the preforms (5) are processed to form at least one flow of preforms aligned in a substantially horizontal flow channel, the preforms exiting said channel being tipped in a second step so as to form at least one flow in which the preforms (5) are substantially vertical. Device for the implementation of said method.

The invention relates to the technical field of methods of manufacturing hollow bodies of thermoplastic material, particularly containers such as jars or bottles, methods in which a preform is first manufactured by injection before obtaining the final container during a stretch blow molding step.

The following definitions are provided solely for purposes of clarity.

These definitions refer to the vocabulary normally used in trades involved in the present invention.

Preform generally designates a substantially tubular object closed at one axial end, commonly called the bottom. The other axial end, provided with an opening, has the definitive shape of the neck of the final hollow body, such as a bottle or vial. This end generally includes the means of attaching the device for capping the final hollow body (threads for screw-on top or reinforced edge for a cap, or other) and is limited by a collar at its junction with the body of the preform, the body being the part between the neck and the bottom. The collar is used for holding the preform or container in various steps of their respective life.

Stretch blow molding designates a method in which a blow nozzle is inserted into the opening (the neck) of this blank. A drawing rod (also called blow tube) stretches the preform in the blow mould by pressing it against the bottom wall of the preform. A highly pressurized blow fluid then presses the material of the blank against the walls of the blow mould. Such a method is used in machines called blow molding machines. Prior to the step of stretch-blowing in the mould, the preforms, made of thermoplastic material, undergo a thermal conditioning phase, i.e., they are heated in a conditioning oven to raise them to a temperature above the glass transition temperature of the thermoplastic material.

High speed blow molding facilities conventionally comprise a large number of stretch blow molding units (moulds) mounted on a carrousel-type rotary machine.

Carrousel stretch blow molding facilities allow high rates of production to be achieved. For a material such as PET, for example, more than 1,500 containers can be produced per hour per mould.

For this type of facility, the feeding of preforms to the blow molding machines is a particularly delicate operation. Starting with preforms in bulk, it consists of orienting them correctly in a substantially vertical position to enter the blow molding machine. This operation is complex for current blow molding machines operating at a rate that can reach 50,000 bottles per hour.

Currently preform feed systems for blow molding machines use devices like unscrambling and alignment hoppers as well as preform feed rails and alignment rollers, i.e., means for evacuating preforms that are improperly oriented, overlapping or stuck together, said means being described for example in the documents FR 2 675 481, FR 2 816 297, and FR 2 864 051.

There is a demand for blow molding machines that can reach manufacturing rates far higher than those of current machines. Consequently, in order to feed preforms to a blow molding machine at a manufacturing rate of about 80,000 bottles per hour or more, very long feed rails and alignment rollers must be provided, requiring a large area for accumulation of preforms, and thus increasing the time the preforms are on the alignment rollers waiting to obtain a maximum number of properly aligned preforms.

In addition to feed rails and alignment rollers, these preform feed devices need devices for ejecting improperly positioned preforms. They have the disadvantages of causing irregularities in the flow of preforms. It is important to have a substantially constant number of preforms entering blow molding machines.

Moreover, the use of very long feed rails and alignment rollers results in having to place the preform feed system several meters above the floor. The work of operators and maintenance personnel is difficult at heights of several meters, necessitating suitable access devices (catwalks, stairs, railings). The use of very long feed rails and alignment rollers and access devices also results in the need for a large amount of floor space.

The present invention seeks to overcome the abovementioned problems.

Furthermore, the present invention proposes a new method of orienting and conveying preforms, as well as a conveyance device for blow molding machines that are suitable for feeding these machines at high rates, typically more than 80,000 preforms per hour.

According to a first aspect, the invention relates to a method of orienting preforms wherein in a first step the preforms are processed to form at least one flow of preforms aligned in a substantially horizontal flow channel, the preforms exiting said channel being tipped in a second step so as to form at least one flow in which the preforms are substantially vertical.

According to a second aspect, the invention relates to a device for implementing the above method, said device comprising, for the implementation of the first step, a tilted or horizontal rotary disk centrifugal distributor.

According to a third aspect, the invention relates to a device for the orientation of preforms from a flow of preforms aligned in a substantially horizontal flow channel, said device comprising three support surfaces, i.e., two high lateral surfaces extending substantially in a first plane and a second low central support surface extending substantially in a second plane inclined with respect to the first plane, the high lateral surfaces being separated by a distance greater than the diameter of the body of the preform and less than the outside diameter of the collar, so that they form receiving surfaces for the collar of the preforms, the low central surface forming, on at least one part of its length, a support surface for the bottom of the preforms.

According to various embodiments, the preform orientation device has the following characteristics which can be combined.

Advantageously, the device is provided with means for modifying the angle of slope of the central support surface with respect to said first plane. It is thus possible to adapt the device to different heights of preforms.

Advantageously, the device is provided with means for modifying the separation between the upper support surfaces. It is thus possible to adapt the device to different widths of preform bodies.

In one advantageous embodiment, the lateral surfaces and the central surface are formed by the upper strands of three endless bands or belts moving substantially at the same speed. The collars and the bottom wall of the preforms are thus driven and guided during the tipping movement of the preforms by their respective receiving or support surfaces, which greatly limits the risk of a rocking movement of the preforms.

In one particular embodiment, a drive shaft or jack shaft is common to the three bands.

In one advantageous embodiment, the three endless bands or belts are substantially identical. The manufacturing and maintenance costs for the device are therefore modest.

Other objects and advantages of the invention will appear from the description of the following figures:

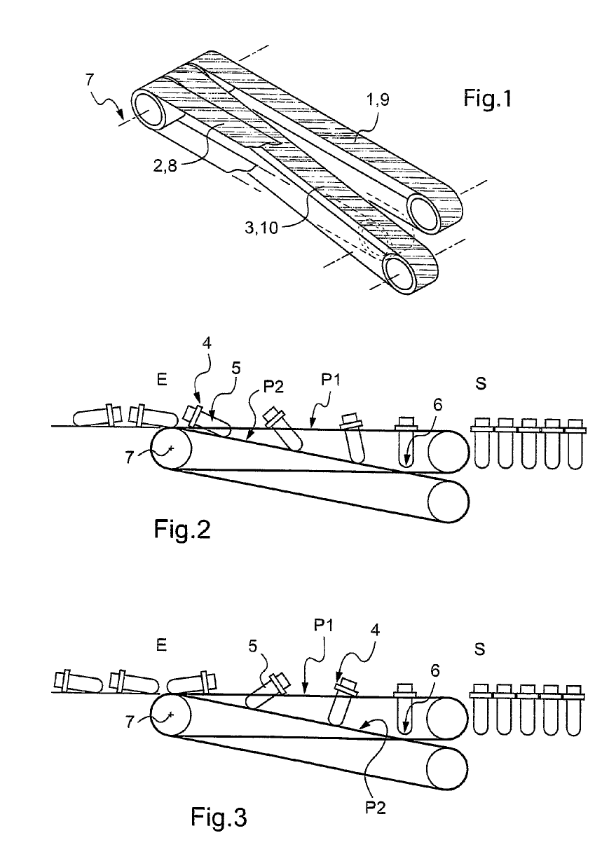

FIG. 1 is a diagrammatical view in perspective of a device according to the invention, a guide roller and a portion of the conveyor band being represented by dashes in this FIG. 3 [sic], in order to make the central band more visible.

FIG. 2 is a side view of a device according to one embodiment of the invention;

FIG. 3 is a side view similar to FIG. 2, the preforms having a different orientation at their input point E of the device.

The applicant has devised a method of orienting preforms wherein, contrary to conventional methods, the orientation of preforms is not performed directly and as soon as possible after the preforms are dumped into an unscrambling hopper.

Quite differently, the applicant has devised a method of orienting preforms wherein, in a first step, the preforms are processed so as to form at least one flow of preforms aligned in a substantially horizontal flow channel, the preforms exiting said channel being tipped in a second step so as to form at least one flow wherein the preforms are substantially vertical.

The two steps of the method are different and are advantageously performed by two different devices.

In one embodiment, for the implementation of the first step a tilted or horizontal rotary disk centrifugal distributor is used. These distributors are known in the field of conveyance of items delivered in bulk, and are often designated by the term centrifugal bowl.

There are various designs of centrifugal bowls. For example, a centrifugal bowl comprises an exterior enclosure receiving a ring mounted in rotation and concentric to the enclosure, and a disk mounted in rotation inside said rink, the axis of rotation of the disk being inclined with respect to the axis of rotation of the ring, the disk and ring being substantially tangent to each other in a transfer zone and being separated from each other in a loading zone. The purpose of this processing is to form a flow of preforms that are aligned with each other, all in a substantially horizontal plane.

In the following description, the terms “input” and “output” are used with reference to the direction of normal operation of the device.

FIG. 1 shows a preform orientation device according to the invention. It comprises three support surfaces, i.e., two high lateral surfaces 1, 2 extending substantially in the same first plane P1, substantially horizontal, and a central low support surface 3 extending substantially in a second plane P2 inclined with respect to the first plane P1. Preferably, as illustrated in the figures, the plane P1 and the plane P2 are secants at the input of said device.

Advantageously, the high lateral support surfaces 1, 2 and the low central support surface 3 are respectively formed by the upper strands of three endless bands or belts 8, 9, 10 moving substantially at the same speed. In this case, the device is equipped with a drive shaft or jack shaft 7 common to the three bands 8, 9, 10.

The bands 8 and 9 are separated by a distance greater than the diameter of the body of the preforms to be righted and less than the outside diameter of their collar, so that their upper strands form receiving surfaces for the collar of the preforms, the low central band 10 forming, on at least one part of the length of its upper strand, the support surface for the bottom of the preforms.

FIGS. 2 and 3 illustrate the manner in which the preforms arriving in the conveyance and orientation device at the input E are processed. The collars 4 of the preforms are engaged by the inner edge of the high lateral surfaces 1, 2. Said surfaces form a receiving surface for the collar 4 of the preforms 5 on either side of the body thereof, and the low central surface 3 forms, on at least part of its length, a support surface for the bottom 6 of the preforms 5.

The high lateral surfaces 1, 2 and the low central surface 3 move substantially at the same speed. Thus, while said surfaces are moving the preforms 5 swing from a recumbent position to a vertical position while being held by their collar and guided gently by the sloping low central surface 3 that accompanies the bottom 6 of the preforms 5 during the swinging movement.

Since the collars 4 and the bottom wall 6 of the preforms 6 are driven and guided during the swinging movement of the preforms 5, the risks of a rocking or pendulum movement of the preforms 5 are eliminated. This proves to be very advantageous when the production rates are very high, on the order of 50,000 preforms per hour and more.

As can be seen in FIGS. 2 and 3, this device operates equally well when the preforms 5 that reach the input E of the device have their opening turned toward said input E or facing away from said input E of the device.

Preferably, the device is provided with means (not shown) for modifying the separation between the upper support surfaces 1, 2. Thus, the device can be adapted to different widths of preform bodies. Advantageously, the device is provided with means (not shown) for modifying the angle of slope of the low central support surface 3 with respect to said first plane P1.

The three bands 8, 9, 10, in the embodiment represented in FIG. 1, are substantially identical. The costs of manufacturing and maintenance are therefore modest. In other embodiments, not shown, the central band 10 is shorter than the two lateral bands 8, 9.

At the output S, the upright preforms can be picked up by any appropriate device (conveyor belts, gravity rails, etc.).

1. Method of orienting preforms wherein, in a first step the preforms are processed to form at least one flow of preforms aligned in a substantially horizontal flow channel, the preforms exiting said channel being tipped in a second step so as to form at least one flow in which the preforms are substantially vertical.

2. Device for implementing the method according to claim 1, said device comprising, for the implementation of the first step, a tilted or horizontal rotary disk centrifugal distributor.

3. Device for the orientation of preforms from a flow of preforms aligned in a substantially horizontal flow channel, said device comprising three support surfaces, i.e. two high lateral surfaces extending substantially in a first plane and a second low central support surface extending substantially in a second plane inclined with respect to the first plane, the high lateral surfaces being separated by a distance greater than the diameter of the body of the preform and less than the outside diameter of the collar, so that they form receiving surfaces for the collar of the preforms, the low central surface forming, on at least one part of its length, a support surface for the bottom of the preforms.

4. Device according to claim 3, characterized in that it is provided with means for modifying the angle of slope of the central support surface with respect to said first plane.

5. Device according to claim 3, characterized in that it is provided with means for modifying the separation between the upper support surfaces.

6. Device according to claim 3, characterized in that the high lateral surfaces and the central surface are formed by the upper strands of three endless bands or belts moving substantially at the same speed.

7. Device according to claim 6, characterized in that a drive shaft or jack shaft is common to the three bands.

8. Device according to claim 6, characterized in that the three endless bands or belts are substantially identical.
